(19) United States
(12) Patent Application Publication
(10) Pub. No.: US 2012/0128317 A1
(43) Pub. Date: May 24, 2012

(54) PORTABLE ELECTRONIC DEVICE WITH POWER TRIGGERED BY COMPONENT ROTATION

(75) Inventor: Hsin-Chih Liu, Taoyuan County (TW)

(73) Assignee: DXG Technology Corp., Taipei (TW)

(21) Appl. No.: 13/299,637

(22) Filed: Nov. 18, 2011

(30) Foreign Application Priority Data
Nov. 19, 2010 (TW) 099222573

(51) Int. Cl. H04N 5/77

(52) U.S. Cl. 386/228; 386/E05.069

(57) ABSTRACT

A portable electronic device including a first component with a recording unit; and a second component is provided. The second component is placed on the first component in a rotatable manner. Besides, power supply of the recording unit is triggered when the second component rotates relatively to the first component from a first position to a second position.

This application claims the benefit of Taiwan application Serial No. 99222573, filed Nov. 19, 2010, the subject matter of which is incorporated herein by reference.

### FIELD OF THE INVENTION

The present invention relates to a portable electronic device, and more particularly to a portable electronic device with its power triggered by component rotation.

### BACKGROUND OF THE INVENTION

With the development of technologies, physical size of storage devices becomes smaller while memory space provided becomes larger. With the enhancement of the compression techniques, audio/video (AV) data nowadays can be compressed and stored to the storage device easily. Therefore, AV equipments such as a portable camcorder are widely used recently, and many consumers purchase the camcorder for recording their precious moments.

It is known that the efficiency of how the camcorder captures images affects the user's experience. Whenever a user wants to switch on the recording function of a conventional camcorder, a power switch has to be pressed to switch on/off the recording function. However, precious moments always pass immediately. If the duration of triggering the recording function and adjustment of lens focusing is too long, the conventional camcorder is not efficient enough for capturing images in time.

Therefore, the initialization of the conventional camcorder is too slow and needs some improvements.

### SUMMARY OF THE INVENTION

Therefore, the present invention relates to a portable electronic device with power triggered by rotation of its component.

An embodiment of the present invention provides a portable electronic device, comprising: a first component with a recording unit; and a second component, placed on the first component in a rotatable manner, wherein power supply of the recording unit is triggered when the second component is rotated relatively to the first component from a first position to a second position.

Another embodiment of the present invention provides a portable electronic device, comprising: a first component; and a second component with a recording unit, placed on the first component in a rotatable manner, wherein power supply of the recording unit is triggered when the second component is rotated relatively to the first component from a first position to a second position.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A˜1D are schematic views of the exterior of a portable electronic device with recording function;

FIG. 2A is a schematic view of the exterior of the portable electronic device in a power off or standby mode;

FIGS. 2B and 2C are schematic views of the exterior of the portable electronic device when the recording function is triggered;

FIG. 2D is a schematic view illustrating the condition when the rotation angle is substantially equal to the preset trigger angle; and

FIG. 3 is a schematic diagram illustrating how the rotation angle varies with the position changes of the second component.

### DETAILED DESCRIPTION OF PREFERRED EMBODIMENTS

As discussed above, there is a need to speed up the triggering process of a portable electronic device (such as a camcorder). Hence the present invention provides an approach to switching on/off a recording unit according to the position of a component. To be more precisely, an rotation angle between a first and second component is used in the present invention to determine whether the power supply of the recording unit is switched on/off

By doing so, no extra time is wasted while switching on/off the portable electronic device. Consequently, precious moments are captured as soon as the user has the portable electronic device in hand. In addition, the user does not have to wait for switching off the portable electronic device either.

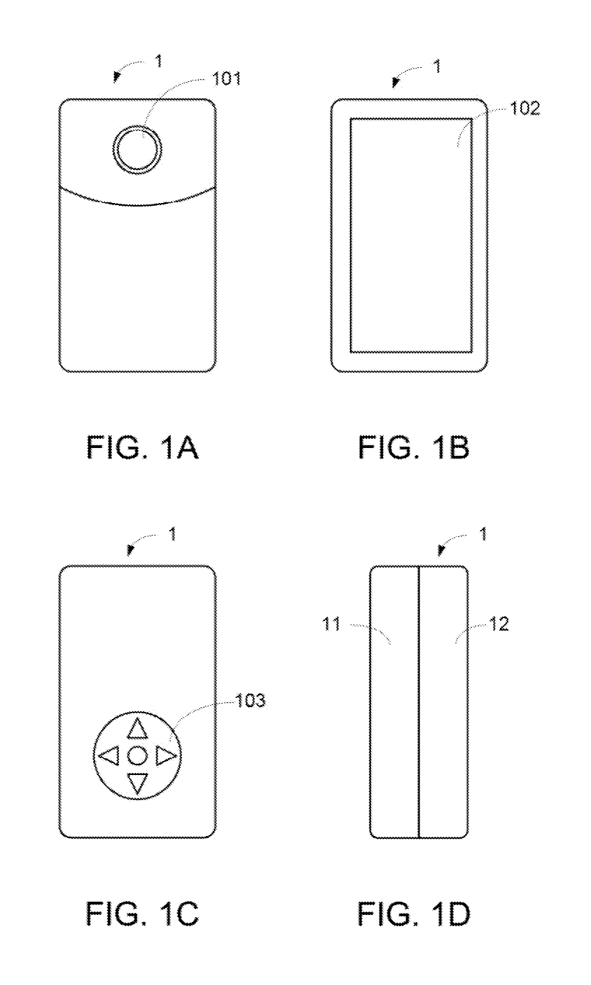

FIG. 1A˜1D are schematic views of the exterior of a portable electronic device with recording function. According to FIG. 1A, a recording unit 101 (e.g. a lens) is used for capturing and recording video images. A display 102 is shown in FIG. 1B for displaying images captured by the recording unit 101. FIG. 1C represents an operation interface of the portable electronic device for providing functions such as zoom-in, zoom-out, or direction movement. FIG. 1D is the side view of the portable electronic device 1.

According to this embodiment, the portable electronic device 1 includes a first component 1, and a second component. The recording unit 101, the display 102, or the operation interface 103 may be optionally placed on either the first component 11 or the second component 12.

Simply speaking, the present invention utilizes the relative position changes between the first and second components 11, 12 to automatically trigger the power of the recording unit 101.

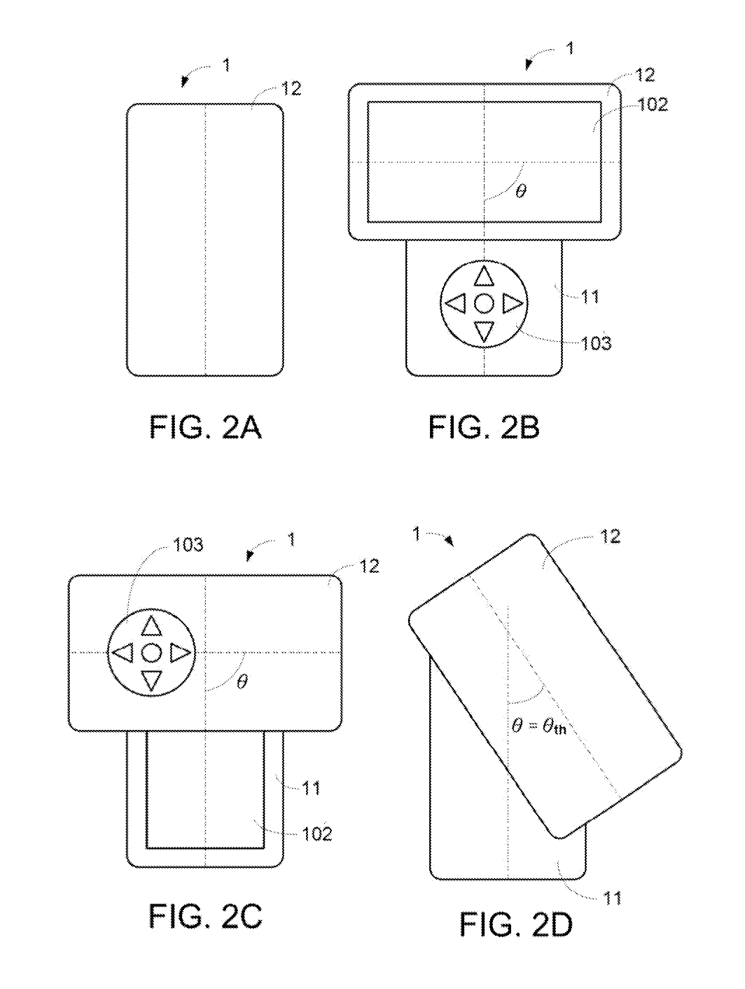

FIG. 2A is a schematic view of the exterior of the portable electronic device in a power off or standby mode. In such case, the first and second components 11, 12 are overlapped together, and the central axes of the two components 11, 12 are overlapping. According to the embodiment of the present invention, the second component 12 is assumed to be on the top of the first component for the sake of illustration. However, the top-down order of the first and second components 11, 12 does not limit the applications of the present invention.

FIG. 2B is a schematic view of the exterior of a first portable electronic device when the recording function is triggered. The recording unit 101, the operation interface 103 are placed on the first component 11. On the other hand, the screen 102 is placed on the second component 12.

FIG. 2C is a schematic view of the exterior of a second portable electronic device when the recording function is triggered. The recording unit 101, the screen 102 are placed on the first component 11. On the other hand, the operation interface 103 is placed on the second component 12. As the recording unit 101 towards direction of the object to be shot, it is on the back of the first and second components. Therefore, the recording unit 101 is not shown in FIGS. 2B and 2C.

According to FIGS. 2B and 2C, a rotation angle θ is defined as the included angle between the central axes of the first and the second component 11, 12 according to an embodiment of the present invention. When the recording unit 101 is ready to record images, the rotation angle θ is a right angle.

According to the embodiment in FIG. 2B, the recording unit 101 is placed at the back of the first component 11, the operation interface 103 is placed on the front side of the first component 11, and the screen 102 is placed at the front side of the second component 12.

According to the embodiment in FIG. 2C, the recording unit 101 is placed at the back of the second component 12, the screen 102 is placed on the front side of the first component 11, and the operation interface 103 is placed on the front side of the second component 12.

FIG. 2D is a schematic view illustrating the condition when the rotation angle is substantially equal to the preset trigger angle. To simplify the explanation, an example of the preset trigger angle θth is selected as 30 degrees. Varied from applications, the degree of the preset trigger angle θth may change.

Therefore, when a user wishes to trigger on the recording function, the second component 12 is rotated relatively to the first component 11. Details of the procedure that the rotation angel θ changes from 0 degree to 90 degrees are discussed below.

Started from 0 degree, the rotation angle becomes greater along with the rotation of the second component 12. As soon as the rotation angle is equivalent to 30 degrees, the recording unit 101 of the portable electronic device 1 starts to be initialized. Once the second component 12 is rotated to a specified position (90 degrees) and starts to record, the initialization control and procedure of the recording unit 101 is complete. As the initialization procedure continues to proceed during the rotation of the second component 12, the speed of switching on the portable electronic device 1 is enhanced.

In addition to the procedure of switching on the portable electronic device, similar approach can be applied to the procedure of switching off the portable electronic device 1. That is, when the rotation angle θ starts to decrease from 90 degrees and becomes less than the preset trigger angle θth (θ≦θth), the power supply of the recording unit 101 is not provided to the recording unit 101, and the portable electronic device is triggered to switch off.

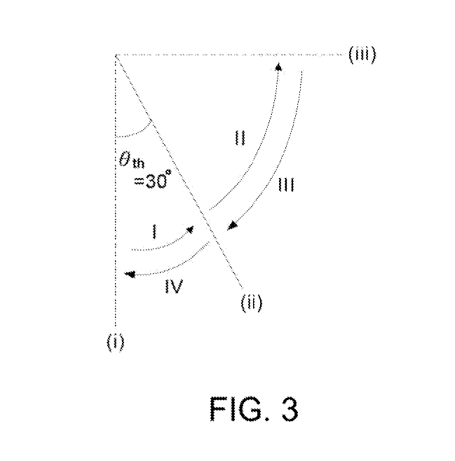

FIG. 3 is a schematic diagram illustrating how the rotation angle varies with the position changes of the second component 12. In FIG. 3, the position of the first component 11 is not changed, and the central axis of the first component 11 towards to a vertical direction. On the other hand, the central axis of the second component 12 is at the first position (i), at the power off or standby mode. With the rotation of the second component, the central axis of the second component changes to the second and third positions (ii), (iii). When the second component 12 is rotated to the second position (ii), the rotation angle θ between the central axes of the first and second component 11, 12 is equal to the preset trigger angle θth (θ=θth).

Consider the case that the portable electronic device 1 is at the power-off or standby mode at the beginning. When a user wishes to operate the portable electronic device 1, the second component 12 is being rotated relatively to the first component 11 until the central axes of the two components 11, 12 are perpendicular to each other. The rotation of the second component 12 can be divided to different stages.

At a first stage I, the rotation angle θ is less than the preset trigger angle θth, and the power supply of the recording unit 101 is not triggered. Therefore, the preset trigger angle θth is used for preventing from mistakenly operation.

At the second stage II, the rotation angle θ is greater than the preset trigger angle θth (θ≧θth). At the meanwhile, the recording unit 101 is powered on and starts to operate. Therefore, when the second component 12 continues to be rotated from the second position (ii) to the third position (iii), the power supply of the portable electronic device continues to provide power to the recording unit 101 simultaneously.

In a case that the second component 12 is rotated relatively to the first component 11 through a third and fourth stage III, IV, the power providing of the recording unit changes in an opposite style.

At the third stage III, the second component 12 is rotated from the third position (iii) to the second position (ii). At the meanwhile, the rotation angle θ is greater than the preset trigger angle, and the power supply of the recording unit 101 is switched on.

At the fourth stage IV, the second component 12 is rotated from the second position (ii) to the first position (i). At the meanwhile, the power supply of the recording unit 101 is not provided and the recording unit 101 is switched off consequently.

According to the descriptions above, two embodiments are provided below. Varied from embodiments, the recording unit 101 is either placed on the first component 11 or the second component 12.

According to the first embodiment, the portable electronic device 1 includes the first component 11 and the second component 12. The second component 12 is overlapped on the first component 11 when the recording unit 101 is power-off or standby. When the second component 12 rotates in relative to the first component 11 from the first position (i) to the second position (ii), the power supply of the recording unit 101 is triggered.

According to the second embodiment, the portable electronic device 1 also includes the first component 11, and the second component 12. The second component 12 exhibits the recording unit 101, and is placed on the first component 11 in a rotated manner. When the second component 12 rotates relatively to the first component 11 from a first position (i) to a second position (ii), power supply of the recording 101 is triggered.

The preset trigger angle θth in the embodiments is used to demonstrate how to trigger the power supply of the recording unit, and its degree may change in different applications. Besides, the recording unit is optionally placed on the first component or the second component.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A portable electronic device, comprising:
a first component with a recording unit; and
a second component, placed on the first component in a rotatable manner, wherein power supply of the recording unit is triggered when the second component is rotated relatively to the first component from a first position to a second position.

2. The portable electronic device as claimed in claim 1, wherein the second component overlaps the first component when the second component is rotated to the first position.

3. The portable electronic device as claimed in claim 1, wherein a rotation angle is formed by central axes of the first and second components.

4. The portable electronic device as claimed in claim 3, wherein the rotation angle is substantially equivalent a preset trigger angle when the second component is rotated to the second position.

5. The portable electronic device as claimed in claim 1, wherein the recording unit is operated via an operation interface.

6. A portable electronic device, comprising:
a first component; and
a second component with a recording unit, placed on the first component in a rotatable manner, wherein power supply of the recording unit is triggered when the second component is rotated relatively to the first component from a first position to a second position.

7. The portable electronic device as claimed in claim 6, wherein the second component overlaps the first component when the second component is rotated to the first position.

8. The portable electronic device as claimed in claim 6, wherein a rotation angle is formed by central axes of the first and second components.

9. The portable electronic device as claimed in claim 8, wherein the rotation angle is substantially equivalent a preset trigger angle when the second component is rotated to the second position.

10. The portable electronic device as claimed in claim 6, wherein the recording unit is operated via an operation interface.
